(19) United States
(12) Patent Application Publication
(10) Pub. No.: US 2009/0177455 A1
(43) Pub. Date: Jul. 9, 2009

(54) Method for animating chemical mechanisms

(75) Inventors: Anamitro Banerjee, Gaithersburg, MD (US); Ronald Marsh, Grand Forks, ND (US); Larry D. Louisiana, II, Ottertail, MN (US)

Correspondence Address: KINNEY & LANGE, P.A., THE KINNEY & LANGE BUILDING, 312 SOUTH THIRD STREET, MINNEAPOLIS, MN, 55415-1002, US

(73) Assignee: University of North Dakota, Grand Forks, ND (US)

(21) Appl. No.: 12/316,644

(22) Filed: Dec. 15, 2008

Related U.S. Application Data
(60) Provisional application No. 61/013,812, filed on Dec. 14, 2007.

(51) Int. Cl. G06G 7/58

(52) U.S. Cl. 703/12

(57) ABSTRACT

A method and system for animating a chemical mechanism begins with user selections of an initial chemical structure and an operation to be performed on the chemical structure via a graphical user interface. Based on these selections, an engine determines a resulting modified chemical structure and a chemical mechanism animation. The chemical mechanism animation includes the initial chemical structure, a modified chemical structure and one or more sequential transition frames illustrating a transition between the initial chemical structure and the modified chemical structure. The chemical mechanism is transmitted to a visual display or another readable medium.

### CROSS-REFERENCE TO RELATED APPLICATION

This application claims the benefit of U.S. Provisional Application No. 61/013,812 filed on Dec. 14, 2007, for “A Method for Animation of Chemical Mechanisms” by A. Banerjee, R. Marsh and Larry Louisiana II, which is incorporated by reference.

### BACKGROUND

The key to understanding organic chemistry is a three-dimensional visualization of the molecules and their interaction with substrates or other reaction compounds. The interaction between two or more molecules (reactants or reagents) leading to a set of new molecules (products) via a series of intermediate species is referred to as a reaction mechanism. Researchers investigate the mechanisms for all known reactions unless the mechanisms have already been established. In books, articles and other scientific manuscripts, the mechanisms are traditionally represented in the form of arrows indicating the movement of electrons. As a typical illustration, Scheme 1 shows the mechanism of E2 elimination. The tail of the arrow indicates the origin of the electrons, while the arrowhead is the destination. This concept can be very difficult for students in organic chemistry courses to grasp.

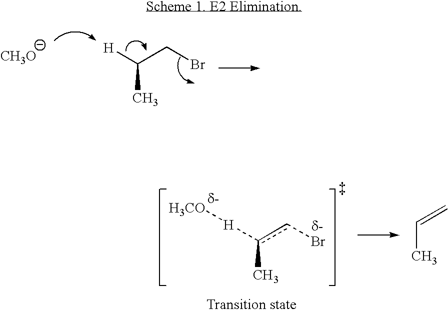

The problem with this representation is that the use of arrows is the only way to represent the mechanism. The three-dimensional orientation of the reaction is rendered two-dimensional. This use of static representation for reaction mechanisms using arrows is the only current tool for teaching or for presentations of chemical reactions. This representation fails to provide the visual tools that can help the reader and audience understand the reaction mechanism.

A very difficult concept for students to grasp is the depiction of organic compounds in various two-dimensional forms (e.g. Newman projections, Fischer projections, etc.). These projections are used to conveniently depict interactions between various functional groups, reactions (e.g. Newman projections are used in explaining Cram's Rule for nucleophilic attack on a carbonyl group, or E2 elimination reactions), or structures (Fischer projections are traditionally used to draw carbohydrates). The conversion of three-dimensional images to these two-dimensional projections is sometimes difficult to envision. Subsequent manipulation (rotations) of these images can even prove tricky for graduate students.

Some instructors have used a series of structures in multi-step reaction mechanisms and manually “animate” them in a PowerPoint presentation. This is a cumbersome and time-consuming process that is prone to mistakes. As a result, only a few simple reactions with well-established mechanisms get “animated” this way and these “animations” are not widely used. Also, the audience fails to understand the three-dimensional orientation as well as the flow/movement of electrons when different intermediate structures appear during the animation.

Some publishers provide instructors with animations of certain reactions using the ball and stick models as AVI (Audio Video Interleave) or QuickTime .mov files. These animation files cannot be modified by instructors. The animations have other drawbacks as well. First, atoms are not labeled which leads to the audience losing track of the atoms. Second, the bonds fade in as they are formed and fade out as they are broken with no indication of heterolytic or homolytic bond formations or cleavages. Third, they cannot be generated by the students, faculty, or other researchers. Additionally, these ball and stick models cannot show the resonance structures, which is a concept that most students struggle with in organic chemistry courses.

There exists a critical need to develop software that will allow the user to draw and animate the reaction mechanism in a manner similar to conventional methods used to illustrate the movement of electrons during a reaction or resonance, and allow three-dimensional manipulations. The present invention resolves all of these key problems and helps to provide the reader or audience with a clearer understanding of the three-dimensional reaction mechanism and the flow of electrons. The unique continuous illustration of chemical reactions provides a more comprehensive understanding of the reaction mechanisms.

### SUMMARY

One embodiment of the invention includes a method for illustrating a chemical mechanism. An initial chemical structure and operation are selected from a graphical user interface. These selections are transmitted to an interactive host, and the interactive host determines a modified chemical structure based on the selections. The interactive host transmits a chemical mechanism animation to a visual display. The chemical mechanism animation includes the initial chemical structure, a modified chemical structure and one or more sequential transition frames illustrating a transition between the initial chemical structure and the modified chemical structure.

Another embodiment includes a method for animating a chemical mechanism. An initial chemical structure and operation input relating to at least a portion of the initial chemical structure are received. A modified chemical structure is determined based on the initial chemical structure and operation input. One or more transition frames are rendered, illustrating a transition between the initial chemical structure and the modified chemical structure. A chemical mechanism animation showing the initial chemical structure, transition frames, and modified chemical structure is transmitted to a readable medium.

Another embodiment includes a system for animating a chemical mechanism. The system includes a database containing chemical structures, a graphical user interface for receiving selections of an initial chemical structure and an operation to be performed on at least a portion of the initial chemical structure from a user, an interactive host for determining a modified chemical structure based on the initial chemical structure and operation selections and rendering one or more transition frames illustrating a transition between the initial chemical structure and the modified chemical structure, and a visual display for displaying an animation resulting from the rendered transition frames.

The present invention relates to a method, system, apparatus, and storage medium for the continuous illustration of a chemical mechanism for a chemical reaction. The user selects the reactants manually or using a database. The preferred invention provides for the illustration of electron transport during the chemical reaction. A further aspect of the invention is that the chemical mechanisms are depicted three dimensionally for the chemical reaction. The apparatus comprises a user accessible chemical illustration and query tool comprising a graphical user interface that optionally includes an interactive host and a database linked to a device for a visual display of one or more chemical structures and a chemical reaction mechanism.

Upon accessing the graphical user interface, the interface guides the user in selecting elements of the molecular compounds or chemical structures residing in a database for a chemical reaction and the correct chemical reaction is provided manually or from the database using the graphical user interface. The chemical reaction is continuously animated throughout the process, depicting intermediate and final products of the chemical reaction. The movement of electrons during the chemical reaction is illustrated by the graphical user interface.

### BRIEF DESCRIPTION OF THE DRAWINGS

FIG. 1 is a block diagram showing the components used in the system and method for animating a chemical mechanism.

FIG. 2 is a flow diagram showing one embodiment of a method of animating a chemical mechanism.

FIG. 3 is a view of one embodiment of a Graphical User Interface (GUI) used in the method.

FIG. 4 is a view of the GUI in which the cyclization reaction mechanism for 1,3-butadiene has been drawn in the drawing area.

FIG. 5 is a view of the GUI in which a scene displays the output of the cyclization reaction mechanism.

FIG. 6 is a view of the GUI in which the transition to a resonance structure for formic acid has been drawn in the drawing area.

FIG. 7 is a view of an intermediate frame of an animation generated from the structure and operation depicted in FIG. 6.

FIG. 8 is a flow diagram illustrating how the Mechanism Animatronic Engine (MAE) fits into the overall program operation.

FIG. 9 is a flow diagram illustrating additional detail for the Animation Mechanics Module (AMM).

### DETAILED DESCRIPTION

In order to accurately describe the invention, the following terms are defined to have the following associated meanings:

“Alcohols” means a group of organic compounds containing alcoholic OH groups (alkyl-oxygen-hydrogen sequence). One or more OH groups can be present. The alkyl group can be open chain, branched, unbranched, cyclic or polycyclic. An alcohol can contain one or more halogens and double and/or triple bonds (conjugated or unconjugated).

“Aldehydes” means a group of organic compounds containing a CHO group also known as the aldehyde group. In an aldehyde, a carbon atom is attached to a hydrogen atom via a single bond in addition to an oxygen atom attached by a double bond. The carbon oxygen double bond functional group is also referred to as a carbonyl group. The carbonyl carbon can be attached to an alkyl or aryl group. One or more aldehyde groups can also be present. The alkyl groups can be open chain, branched, unbranched, cyclic or polycyclic. An aldehyde can contain one or more halogens, thiols, thioethers, ether linkages, OH groups, and double and/or triple bonds (conjugated or unconjugated).

“Alkanes” means a group of organic compounds that includes branched and unbranched hydrocarbons and cyclic (rings), polycyclic, and open chain compounds and combinations thereof. It also includes compounds such as spiranes and catenanes.

“Alkenes” means a group of organic compounds that includes branched and unbranched alkenes (contain a carbon-carbon double bond) and cyclic (rings), polycyclic, and open chain compounds, and combinations thereof. Alkenes also include compounds with multiple carbon-carbon double bonds that may or may not be conjugated (alternate double and single bonds). It also includes cumulenes (more than one consecutive double bond).

“Alkyl group” means a group of atoms with a particular connectivity derived from alkanes. It has one less hydrogen atom than its respective alkane counterpart and is a part of a larger molecule. An alkyl group may have other functional groups as one of its parts, though the point of attachment to the larger molecule must be a carbon atom.

“Alkylhalides” means a group of organic compounds containing a halogen (fluorine, chlorine, bromine, iodine, astatine) species. One or more halogens can be present. The organic component can be an aryl or an alkyl group. The alkyl group can be open chain, branched, unbranched, cyclic, polycyclic or a combination of the preceding. Alkylhalides can contain one or more double and/or triple bonds (conjugated or unconjugated).

“Alkynes” means a group of organic compounds that include branched and unbranched alkynes (contain a carbon-carbon triple bond) and cyclic (rings), polycyclic, and open chain compounds, and combinations thereof. Alkynes can also contain carbon-carbon double bonds in addition to triple bonds. Alkynes also include compounds with multiple carbon-carbon triple and/or double bonds that may or may not be conjugated (alternate triple (and/or double) and single bonds).

“Amines” means a group of compounds containing a nitrogen atom linked to one, two, or three alkyl groups and/or aryl groups, with hydrogen atoms occupying the remaining spots. One or more amine groups can be present. The alkyl groups can be open chain, branched, unbranched, cyclic, polycyclic or a combination of the preceding. Amines can contain one or more carboxylic acid groups, their derivatives, keto groups, aldehyde groups, halogens, thiols, thioethers, ether linkages, OH groups, double and/or triple bonds (conjugated or unconjugated), and combinations thereof.

“Aromatic Compounds” means a group of compounds that satisfy the description of aromaticity in Chapter 10 of “Advanced Organic Chemistry, Part A: Structure and Mechanism”, F. A. Carey and R. J. Sundberg, 4^{th} edition, Kluwer Academic/Plenum Press, New York, 2000. These compounds can also have one or more other functional groups described above (or as described by “organometallic compounds”) directly attached to the aromatic ring or elsewhere in the molecule.

“Aryl group” means a group derived from aromatic rings (such as benzene, pyridine, naphthalene, etc.). It has one less hydrogen atom than the particular aromatic ring and is a part of a larger molecule. In general terms an aryl group can have other functional groups as one of its parts, though the point of attachment to the larger molecule must be an atom that is a part of the aromatic ring.

“Carbonyl group” means a group of organic compounds containing a carbon atom attached to an oxygen atom via a double bond. The carbonyl group is attached to two other atoms via the carbon, referred to as the “carbonyl carbon.” The carbonyl group is present in a variety of functional groups such as aldehydes, ketones, carboxylic acids, amides, and esters.

“Carboxylic Acid Derivatives” means a group of compounds that can be derived from carboxylic acids and which can also be converted back to the carboxylic acids upon treatment with water in the presence of an acid or a base. Examples include amides (carbonyl group attached to nitrogen, including cyclic amides called “lactams”), acid anhydrides (two carbonyl groups attached to each other via an oxygen atom), acid halides (carbonyl group attached to a halogen), esters (carbonyl group attached to an oxygen, which in turn is attached to an alkyl or aryl group, including cyclic esters called “lactones”), and nitriles (carbon triple-bonded to nitrogen). The alkyl groups can be open chain, branched, unbranched, cyclic or polycyclic. Carboxylic acid derivatives can contain one or more carboxylic acid groups, keto groups, aldehyde groups, halogens, thiols, thioethers, ether linkages, OH groups, double and/or triple bonds (conjugated or unconjugated), and combinations thereof.

“Carboxylic Acids” means a group of compounds containing a carbonyl group linked to an oxygen-hydrogen sequence (OH group) and an alkyl group or an aryl group. One or more carboxylic acid groups can be present. The alkyl groups can be open chain, branched, unbranched, cyclic or polycyclic. Carboxylic acids can contain one or more keto groups, aldehyde groups, halogens, thiols, thioethers, ether linkages, OH groups, double and/or triple bonds (conjugated or unconjugated), and combinations thereof.

“Compounds with Multiple Functional Groups” means any group of organic compounds that contain more than one functional group. For example biologically important molecules such as proteins and amino acids, carbohydrates, nucleic acids, DNA, RNA, lipids, alkaloids, steroids, etc. (found in nature, as well as chemically synthesized analogs) contain multiple functional groups. These functional groups can exist in neutral form or, depending on the pH or presence of other functional groups, can exist as cations, anions or zwitterions. These functional groups can play structural as well as functional roles in these molecules.

“Compounds with Other Functional Groups” means any compound from the following functional groups, but not limited to: azides, peroxides, peracids, oxetanes, dioxetanes, diazonium salts, xanthanes, nitro, isocyanates, nitroso, phosphates, and phosphate esters. Some compounds can also be present as radicals (e.g. triphenylmethyl radical, TEMPO, etc.).

“Ethers” means a group of organic compounds containing alkyl-oxygen-alkyl or aryl-oxygen-aryl sequence (referred to as the ether linkage). One or more ether linkages can be present, and some can be part of a ring (e.g. epoxides, tetrahydrofuran, etc.). Alkyl groups in ethers can be open chain, branched, unbranched, cyclic or polycyclic. Ethers can contain one or more halogens, OH groups, double and/or triple bonds (conjugated or unconjugated), and combinations thereof.

“Ketones” means a group of compounds containing a carbonyl group linked to two alkyl groups, two aryl groups, or one alkyl group and one aryl group. One or more keto groups can be present in a ketone. Alkyl groups in ketones can be open chain, branched, unbranched, cyclic or polycyclic. Ketones can contain one or more aldehyde groups, halogens, thiols, thioethers, ether linkages, OH groups, double and/or triple bonds (conjugated or unconjugated), and combinations thereof.

“Organometallic Compounds” means a group of compounds that includes all compounds having a metal attached to an alkyl group carbon or an aromatic ring carbon by a covalent bond. One or more of the other functional groups described above can be present in organometallic compounds.

“Thioethers” means a group of organic compounds containing alkyl-sulfur-alkyl, or aryl-sulfur-aryl sequence (referred to as the thioether linkage). One or more thioether linkages can be present. Alkyl groups in thioethers can be open chain, branched, unbranched, cyclic or polycyclic. Thioethers can contain one or more halogens, thiols, ether linkages, OH groups, double and/or triple bonds (conjugated or unconjugated), and combinations thereof.

“Thiols” means a group of organic compounds containing an alkyl-sulfur-hydrogen sequence (referred to as the thiol group). One or more thiol groups can be present. Alkyl groups in thiols can be open chain, branched, unbranched, cyclic or polycyclic. Thiols can contain one or more halogens, ether linkages, OH groups, double and/or triple bonds (conjugated or unconjugated), and combinations thereof.

“Accretion” means a shorthand abbreviation for a molecule or common molecular group or subgroup in addition to the representation of a molecule in abbreviated form. One example of an accretion is “CH₃”, used to represent a methyl group. Performing an “accretion” on a molecule or functional group entails changing the representation of the molecule or functional group from an expanded representation to an abbreviated form. Similarly, “deaccretion” means changing the representation of a molecule or functional group from an accretion to an expanded representation.

“Actor” means an object-oriented programming (OOP) construct that is a type of calculation or manipulation applied to a data set.

“Actor package” (AP) means a group of actors objects (OOP), referenced by a time variable, which are active during a reference time.

“Arrow” means a type of actor used to symbolize electron movement, rearrangement, resonance, vibration, rotation, projection, relaxation, excitation, accretion, deaccretion and any combinations thereof. This includes interactions, behaviors or associations of nuclei currently discovered or as yet undiscovered, interaction or movement of symbolic nuclei or nuclei accretions/collections with an electron and any combinations thereof. In the graphical user interface (GUI), arrows represent a manipulation of a chemical structure.

“Compose” means the user process of depicting a mechanism of interest on a drawing surface or in a data file. The process is a GUI-based scripting process.

“Continuous” means that a display includes two or more sequential depictions of a reaction mechanism. A continuous animation preferably contains more than 10 depictions, more preferably contains sufficient displays to show movement representative of the reaction mechanism, and most preferably contains a smooth visual depiction of the reaction mechanism.

“Engine” means a routine that takes data and formatting information and displays the formatted content on an image or performs a series of formatted tasks on the data.

“Functional Group” means an atom or a group of atoms linked in a particular way that imparts characteristic physical and/or chemical properties to a compound. One or more functional groups can be present in a molecule, in which case all or some of the functional groups influence the physical and/or chemical properties of the molecule.

“Frame Cycle” means one revolution of the cycle of the process of rendering all the objects in an AP or scene including all the modifications needed to progress the animation at some time.

“Graphical User Interface” (GUI) means the hardware and software used to allow the user to interact with the program, and for the program to interact with the user. THE GUI includes, but is not limited to, hardware such as a keyboard, mouse and software features such as windows, buttons, tabs, panels, panes, toolboxes, and the like.

“Interactive Host” means a computer or client. The Interactive Host can be attached to a network or server.

“Intramolecular Interaction” means a change inside a molecule where the center of gravity of the molecule remains stationary with respect to the screen.

“Mechanism” means any process that depicts the progress of a reaction or a step of a reaction from a starting compound to a product in terms of formation or cleavage of a bond. A mechanism can involve resonance structures and reorientation or rotation of groups, with or without stereochemical (three-dimensional) considerations.

“Module” means a grouping of data manipulation functions or queries that may or may not be embodied or delineated as distinct functions or queries used in parallel or series to attain a purpose or common goal.

“Molecular Interaction” means a change in one or more molecules with respect to the screen and to each other.

“Movie” means a media form, possibly portable, made by creating images using animation techniques can be sent to various formats, HDTV, DVD, web streaming, or WMV/FLV/Quicktime/MPEG4.

“Pre-roll” means an amount of scene frames prior to the portion of the scene that has been modified or depicts the actor actions on the data set, usually depicting the initial state of the data set before modifications have been made.

“Post-roll” means an amount of scene frames after the portion of the scene that has been modified or depicts the actor actions on the data set, usually depicting the final state of the modifications made.

“Vectorial movement” means using a ray or arc to suggest an end point. Vectorial movement is normalized per AP (generating normal units per actor) to an estimate of the relative length from origin to end point and incremented one normal unit per frame cycle per actor.

The present invention is a method for animating simulations of chemical mechanisms to produce a visual illustration of the chemical mechanisms. Chemical mechanism representations include, but are not limited to, chemical reactions, electron movement, bond formation, bond cleavage, resonance, chemical movements, chemical structure interconversions and intraconversions, excitation, relaxation, changes in projection, accretions, deaccretions and combinations thereof. Some embodiments of the invention can include the depiction of more detailed aspects of chemical reactions and chemical mechanisms including, but not limited to, rotation, projection, translation, vibration, conformation, excitation, relaxation and combinations thereof.

The present invention is operable as a system or program used on a computer. Furthermore, the present invention is operable in embodiments of hardware, software, or both software and hardware. The system or program can be recorded on any computer-readable medium such as a hard disk, CD-ROM, DVD-ROM, optical recording system, magnetic recording system, ROM, PROM, EPROM, or EEPROM. The program can be also recorded on another computer over a network.

In one embodiment, a program is stored on a computer-readable storage medium. The program contains code which provides a set of instructions to allow one or more hardware and/or software components to implement a method of animating a chemical mechanism. Such a method generally includes instructions for acquiring selections of an initial chemical structure and an operation to be performed on at least a portion of the initial chemical structure, determining a modified chemical structure based on the acquired selections, rendering one or more transition frames illustrating a transition between the initial chemical structure and the modified chemical structure, combining the initial chemical structure, the transition frames and the modified chemical structure into a chemical mechanism animation, and transmitting the chemical mechanism animation to a readable medium.

One embodiment of the method generally includes selection of an initial chemical structure, selection of an operation to be performed on at least a portion of the initial chemical structure, processing the selected operation to determine a resulting modified chemical structure, rendering one or more transition frames illustrating a transition between the initial chemical structure and the modified chemical structure, combining the initial chemical structure, the transition frames and the modified chemical structure into a chemical mechanism animation, and transmitting the chemical mechanism animation to a readable medium.

An initial chemical structure and an operation to be performed on the initial chemical structure are determined by user input. In one embodiment, a user selects a chemical structure and an operation to be performed on the chemical structure. Multiple chemical structures and multiple operations on one or more structures can also be selected. User knowledge of the art of chemical drawing is desirable, however, it is not necessary (as manuals can be provided to familiarize the user with these methods). The user draws the chemical structure and operation in a commonly accepted method using atomic elements or functional groups and, if desired, can edit characteristics of how the animation is to be constructed. Once the user has drawn the desired chemical structure(s) and the desired operation(s), the chemical mechanism is determined and displayed. One embodiment of the present invention displays a continuous chemical mechanism, which includes intermediate and final product(s). The continuous display includes two or more depictions of the chemical mechanism, preferably more than ten depictions, more preferably sufficient displays to show movement, and most preferably a smooth visual depiction of the selected chemical mechanism. Continuous display is a forward driven frame extrapolation, using a user defined frame time step. The continuous display of chemical mechanisms provides the user with a unique and novel depiction to aid the user in understanding chemical reactions and mechanisms. In one embodiment, the animation of the chemical mechanism simulation is presented in two dimensions. In another embodiment, the simulation can be shown in three dimensions.

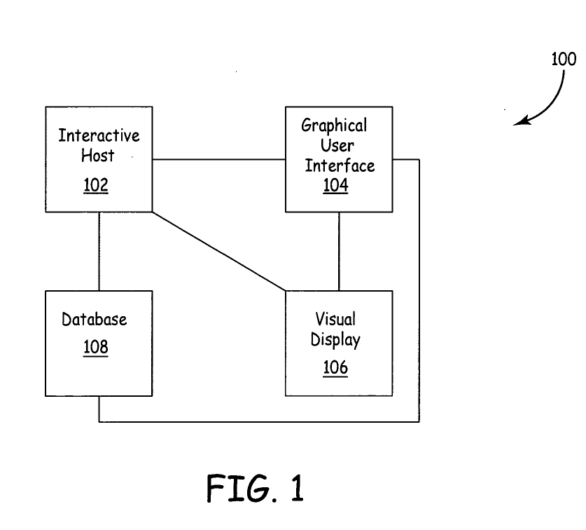

FIG. 1 is a block diagram illustrating one embodiment of a system used to animate chemical mechanisms. Animation system 100 includes interactive host 102, graphical user interface (GUI) 104, visual display 106 and database 108. Interactive host 102 contains an engine (not shown in FIG. 1) which determines the product(s) of a chemical mechanism. Interactive host 102 communicates with GUI 104, visual display 106 and database 108. GUI 104 facilitates program communication with a user. GUI 104 communicates with interactive host 102, visual display 106 and database 108. Visual display 106 receives a chemical mechanism animation from interactive host 102. Visual display 106 can also convey information to the user as part of GUI 104. Database 108 contains chemical structures such as atoms, molecules and functional groups. Database 108 communicates with GUI 104 to allow the user to select chemical structures from database 108.

Generally, the user selects an initial chemical structure and an operation using GUI 104. GUI 104 accesses database 108 to provide a list of chemical structures. Once the initial chemical structure and operation are selected, the selections are communicated to interactive host 102. Interactive host 102 determines the product resulting from the selected initial chemical structure and operation and generates an animation reflecting the transition from the initial chemical structure to the product. This animation is communicated to visual display 106 for viewing by the user or another viewer.

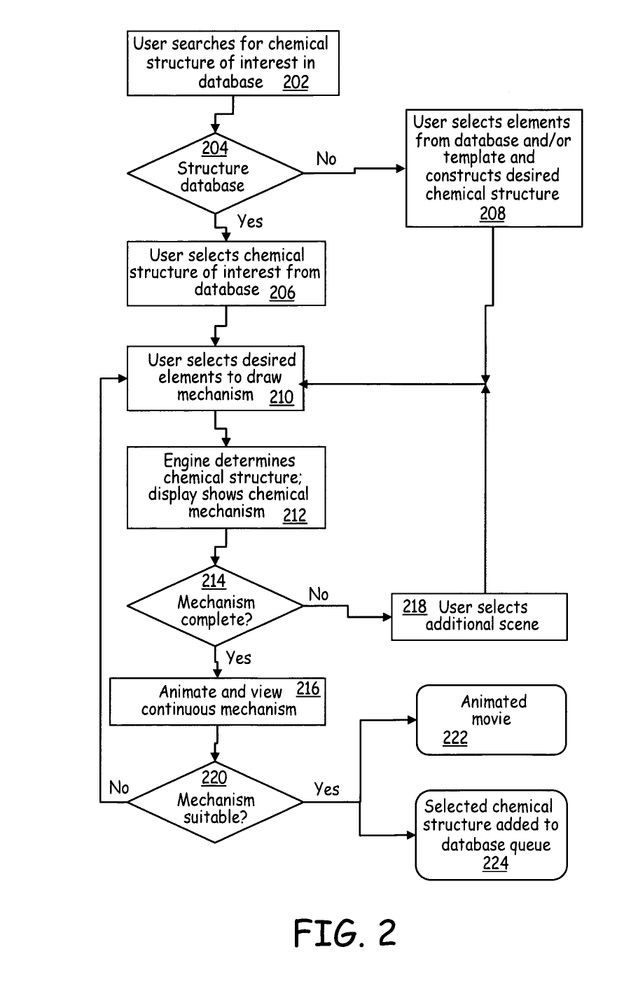

FIG. 2 illustrates the general process flow of one embodiment of a method of animating a chemical mechanism. The method is facilitated through use of a visual display, a GUI, an interactive host, and a database such as those described in FIG. 1. A user searches for a chemical structure of interest in a chemical structure database in step 202. Chemical structures include, but are not limited to: alkanes, alkenes, alkynes, alkyl groups, aryl groups, alkylhalides, alcohols, ethers, thiols, thioethers, carbonyl groups, aldehydes, ketones, carboxylic acids, carboxylic acid derivatives, amines, aromatic compounds, organometallic compounds, compounds with other functional groups, compounds with multiple functional groups, and combinations thereof. The chemical structure database can contain various stock or user-determined atoms, molecules, functional groups, and other chemical structures. If the desired chemical structure is present in the database, determined in step 206, the user can select that particular chemical structure of interest from the database, illustrated in step 208. If the chemical structure does not exist in the database, the user can select atoms, functional groups, molecules, etc. from the chemical structure database with which to construct the desired chemical structure, or select individual atomic elements to construct the desired chemical structure in step 210.

Once the initial chemical structure is selected or constructed, the user selects the desired operation(s) (actors) involved in the chemical mechanism in step 210. Recognized chemical mechanisms include, but are not limited to, aliphatic nucleophilic substitutions; aromatic nucleophilic substitutions; aliphatic electrophilic substitutions; aromatic electrophilic substitutions; free radical substitutions; addition to carbon-carbon multiple bonds; addition to carbon-heteroatom multiple bonds; addition to heteroatom-heteroatom multiple bonds; isomerization reactions; elimination reactions; condensation reactions; rearrangements; acid-base reactions; oxidation-reduction reactions; photochemical reactions; pericyclic reactions; reactions of free radicals, carbenes and other reactive intermediates; formulation and reactions of organometallic compounds; multistep reactions, which can be a combination or a sequence of one or more reactions listed above; any other reaction type that might be discovered in the future that could be depicted by flow of single or paired electrons; excitation; relaxation; vibration; changes in projection; accretions, deaccretions and combinations thereof.

In one embodiment, the operation(s) of the chemical mechanism are generally communicated through the GUI by one or more arrows. Depending on their context, arrows can indicate operations including, but not limited to, electron movement, rotation, vibration, resonance, rearrangement, projection, relaxation, excitation and combinations thereof. Arrows can have different qualities to reflect different operations. Arrow qualities can include, but are not limited to, color, dashed line, dotted line, curved line, squiggly line, waveform representation and combinations thereof. For example, in one embodiment, a sine waveform arrow can represent rotation while a dashed arrow represents electron movement. In one embodiment, the user can select arrow qualities and the operations they reflect. In other embodiments, alternate conventions (i.e. non-arrow) and commands communicate the operations of the chemical mechanism through the GUI.

Once an operation has been selected, an engine determines the product (modified chemical structure) of the operation on the initial chemical structure in step 212. In one embodiment, the initial chemical structure and the operation are transmitted to an interactive host, which contains the engine. As discussed in detail below, the engine determines the product (modified chemical structure) of the operation on the initial chemical structure and generates a series of transition frames illustrating the chemical mechanism. The transition frames are combined with the initial chemical structure and product to generate a scene. The scene illustrates the chemical mechanism as the chemical structure transitions from its initial state to its modified state (product). This scene is then transmitted to the visual display.

The engine determines the product (modified chemical structure) of the chemical mechanism selected by the user. The engine is able to determine where electrons move, what bonds are formed or broken, the atomic charges of the product(s), resonance structures, molecular translation, etc. Unlike other chemical drawing programs, the user does not select the product (or intermediate) in addition to the starting material. The product is determined automatically by the engine. The engine also determines the product (modified chemical structure) regardless of whether the modified chemical structure as depicted is physically possible. If an incorrect operation is selected or the initial chemical structure is drawn (selected) incorrectly, the engine will continue to carry out an incorrect chemical mechanism. By simulating a chemical mechanism with its errors, the present invention can serve as a valuable teaching tool.

Once transmitted, the visual display shows the continuous steps of the scene of the chemical mechanism in step 212. The scene depictions can include, but are not limited to, bond cleavages, bond formations, electron transfer, rotations, transformations, excitation, relaxation, changes in projection, accretions, deaccretions and the like. Step 212 includes generating the scene's end product, which can be the final product of a chemical mechanism or an intermediate step in the overall mechanism. If the mechanism is complete, determined in step 214, the user can animate the chemical mechanism and view the simulation of the chemical mechanism in step 216. If the chemical mechanism is not complete, the user can choose to prepare an additional scene in step 218. The user then returns to step 210 to add an additional operation where the modified chemical structure (product) becomes the initial chemical structure for the ensuing operation.

Once the chemical mechanism is viewed in step 216, the user indicates whether the mechanism is complete and acceptable in step 220. If additional operations or changes to existing operations need to be made, the user returns to step 210 for operation additions and/or revisions. If the chemical mechanism is suitable, an animated movie can be created and stored for later use in step 222. Acceptable file formats for the animated movie include but are not limited to .avi and .mov files. In one embodiment, the animated movie can be viewed using a variety of visual displays that include, but are not limited to, computer monitors, electronic book media, and other display media for single or group users.

Optionally, the chemical structures (initial and modified) depicted in the animated movie can also be added to a chemical structures database append queue in step 224, where they can be periodically reviewed by a database provider and new content can be added to the chemical structure database.

Once the animated movie is created, it can then be viewed as one continuous illustration of the chemical mechanism selected by the user. When displaying a multi-step chemical mechanism (e.g., electron transport), the user or viewer is given the option of showing all steps, or can select specific steps in the mechanism to be shown. If it is desirable to use the program as a lecture tool, the animated movie can be viewed as part of a PowerPoint presentation or as a .mov file that will run on a computer with the aid of QuickTime. If it is desirable to use the program as a learning tool, the animated movie can also be viewed using an interactive electronic book. Animated movies created according to the method can also be edited using appropriate video file editing tools or software.

### Example 1

### Graphical User Interface (GUI) Basic Options

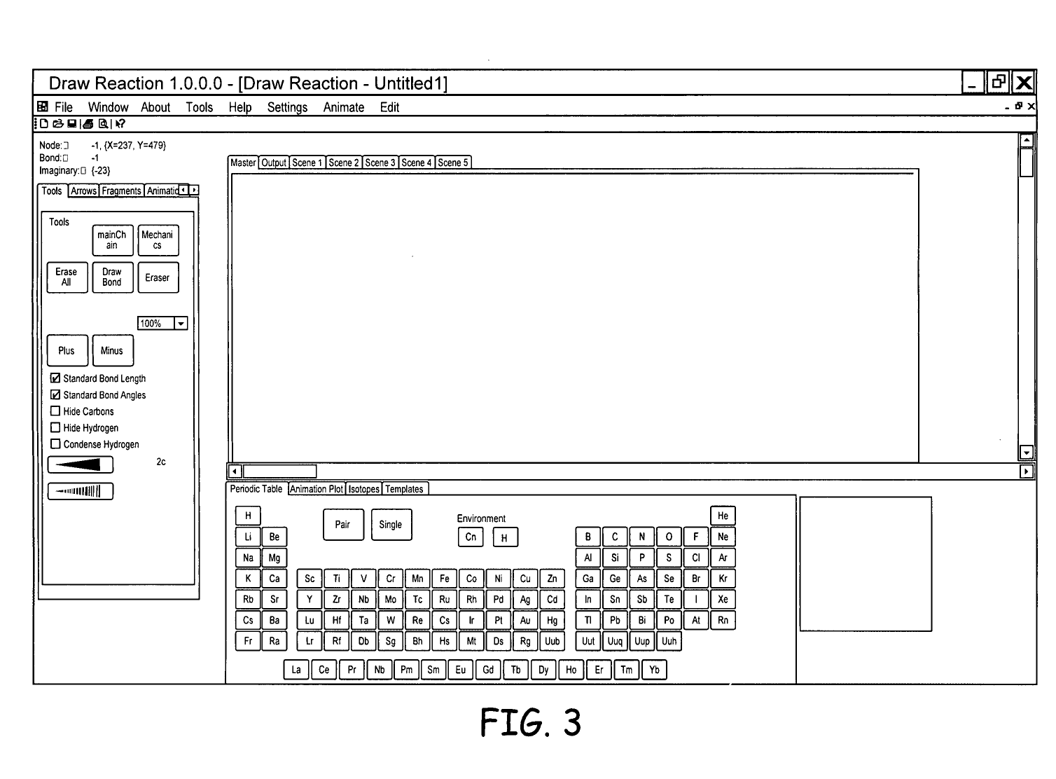

FIG. 3 shows a snapshot of one embodiment of the GUI screen when the animation program is activated. It serves as the primary drawing window. The large white window is the drawing area. Above the drawing area are scene buttons, which lets the user draw different scenes of the chemical mechanism. For example, the first step of the mechanism is “Scene 1”. Once instructed, the program generates the product (modified chemical structure) of Scene 1. When “Scene 2” is selected for animating the second step of the mechanism, the product of Scene 1 appears as the starting point (initial chemical structure) of Scene 2. The program generates the end point of a scene, which in turn is the starting point for the next scene. This process is repeated for subsequent scenes depending on the number of steps the chemical mechanism contains. The overall drawing is reflected in the “Master” window and the final output is illustrated in the “Output” window.

On the left side of the drawing window are “Tools”, “Arrows”, “Fragments” and “Animations” panels. The “Tools” panel is used for drawing and editing chemical structures. It also contains buttons for atomic charges (“Plus” and “Minus”), fixed bond length and angles, as well as drawing condensed structures and line angle drawings. Bond lengths and angles can be set according to user preference (e.g., set uniform values, database values or manual entry). The “Arrows” panel allows the user to draw a “Smart Arrow” indicating various electron movements (e.g., bond formation or homolytic or heterolytic bond cleavage) for each scene. Other “Arrow” functions include arrows for “Rotation”, “Projection” and three-dimensional manipulation of chiral centers. Rotational elements (including intramolecular and molecular) can also be described using X, Y, and Z axes. Mixing of these axes can yield roll, pitch and yaw rotations. The “Plus” and “Minus” buttons are used to add positive or negative charges to atoms, respectively. The two buttons under the “Condense Hydrogen” checkbox are used for drawing the bonds in perspective, using the conventional triangle bond approach. The “Fragments” panel contains tool tips to indicate common alkyl, aryl, or other functional groups commonly found in organic compounds, and can also be used for accretion or symbolic input. The “Animations” panel allows the user to change various animation options. For example, the user can choose whether to show the electrons or the arrows during animations. If the electrons and arrows are shown, various options allow for fading in and out the electrons, arrows, and bonds. It also allows the user to choose the speed of animation, movement of atoms (nodes) during animation, or the display of atomic charges. The user can also select whether the animation contains accretions or illustrates all of a chemical structure's atoms (i.e. CH₃ or C(—H)(—H)(—H)).

Below the drawing area, the “Periodic Table” panel lists all the known elements that can be added into chemical structures using the “Tool” panel. The “Pair” and “Single” buttons are used to assign a lone pair of electrons or a single electron (radical) to an atom. The “Environment” group box is used in conjunction with the drawing tool, and allows the program to draw CH₃ (a methyl group), wherever a singly bonded carbon is attached to the chemical structure. This can be used in conjunction with accretions to facilitate drawing of the chemical structure. Examples of accretions include Me or CH₃ for representing a methyl group (CH₃) with the expanded structure C(—H)(—H)(—H) with additional accretion representations being CH(—H)(—H) and CH₂(—H). Similarly, acetic acid can be represented as an accretion such as H₃C₂O₂H or as an expanded structure such as H—C(—H)(—H)—C(═O)—O—H. The “Animation Plot” panel provides a text format for editing the animation. The “Isotopes” panel allows the user easy access to isotopic variants of commonly used elements in organic chemistry. The “Templates” panel allows the user easy access to templates of chemical and reaction mechanisms and molecules, and their fragments.

### Example 2

### Cyclization Reaction Mechanism for 1,3-butadiene

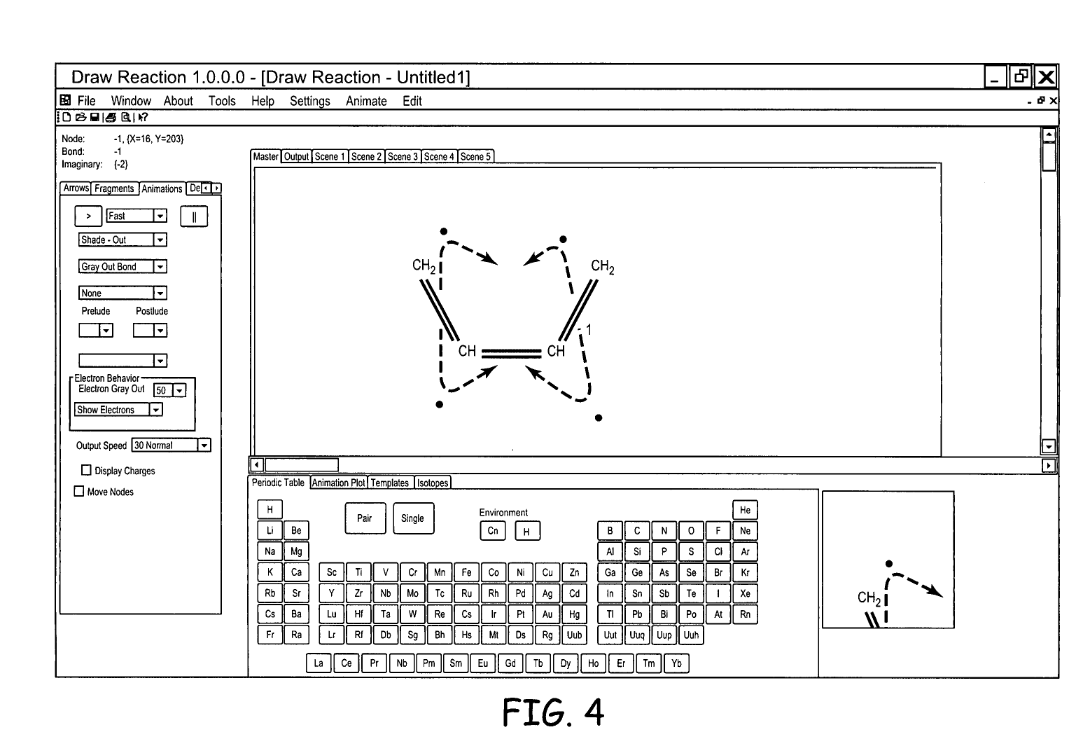

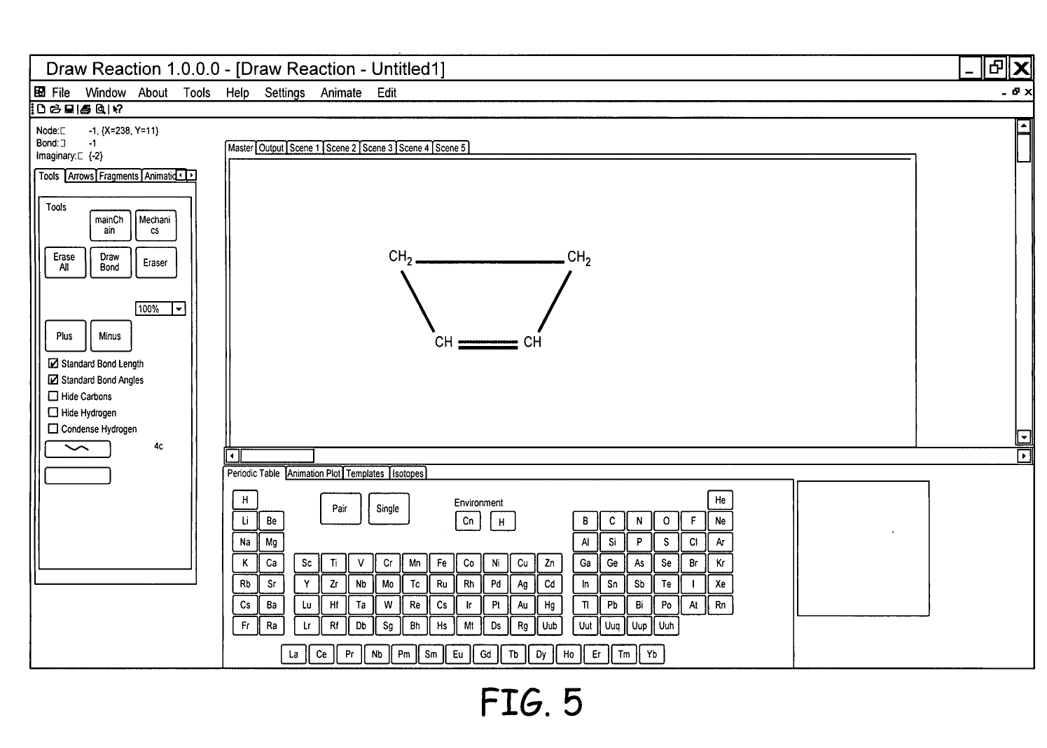

FIGS. 4 and 5 show snapshots of screens depicting the cyclization mechanism of 1,3-butadiene to cyclobutene (an example of a thermal or photochemical pericyclic reaction). FIG. 4 shows a snapshot of the starting compound (1,3-butadiene) and “Smart Arrows” drawn to indicate homolytic cleavage (each arrow represents the movement of one electron). The number “1” beside one of the carbon-carbon double bonds (lower right) indicates that bond scission occurs at that bond in scene 1. In this case, all the electron movements are taking place at the same time, hence the Master and Scene 1 appear identical. FIG. 5 shows the “Output” of the animation, in this case cyclobutene. Using the “Animate” pull down menu on the file bar completes the process of animation and creates an animated movie file.

### Example 3

### Transition to a Resonance Structure for Formic Acid

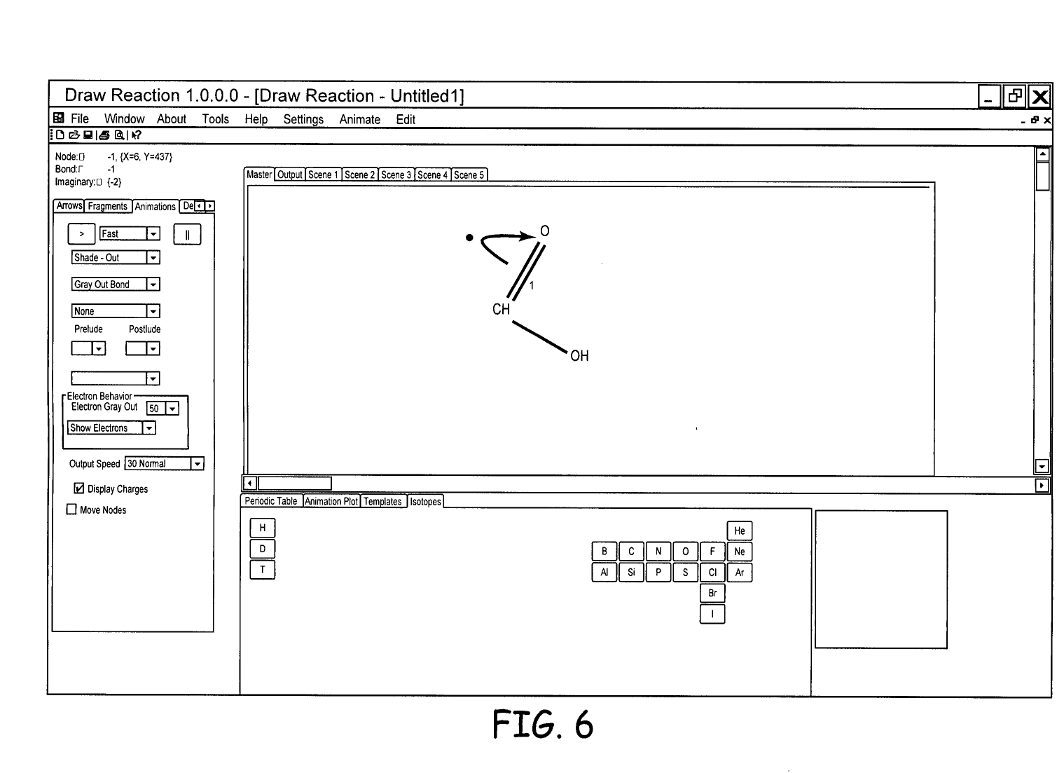

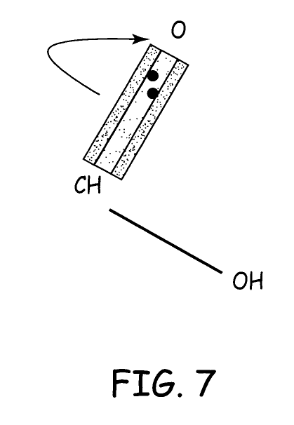

FIGS. 6 and 7 display snapshots of screens depicting the resonance of formic acid. FIG. 6 shows formic acid with a “Smart Arrow” indicating the movement of two electrons from the carbon-oxygen double bond to the oxygen atom. The “1” beside the carbon-oxygen double bond indicates that the electron movement occurs in scene 1. FIG. 7 is a screen shot of an animation frame showing the double bond disappearing. The two electrons, represented by “••”, are clearly visible, appear near the center of the remaining bond, and are closer to the oxygen atom than the carbon atom in this screenshot. During the complete animation sequence, the double bond and the arrow fade out, while the faint single bond (seen between the two lines of the fading double bond) replaces the double bond. The respective positive and negative atomic charges also appear on the carbon and oxygen atoms.

### Example 4

### Block Diagram of Overall Program Operation

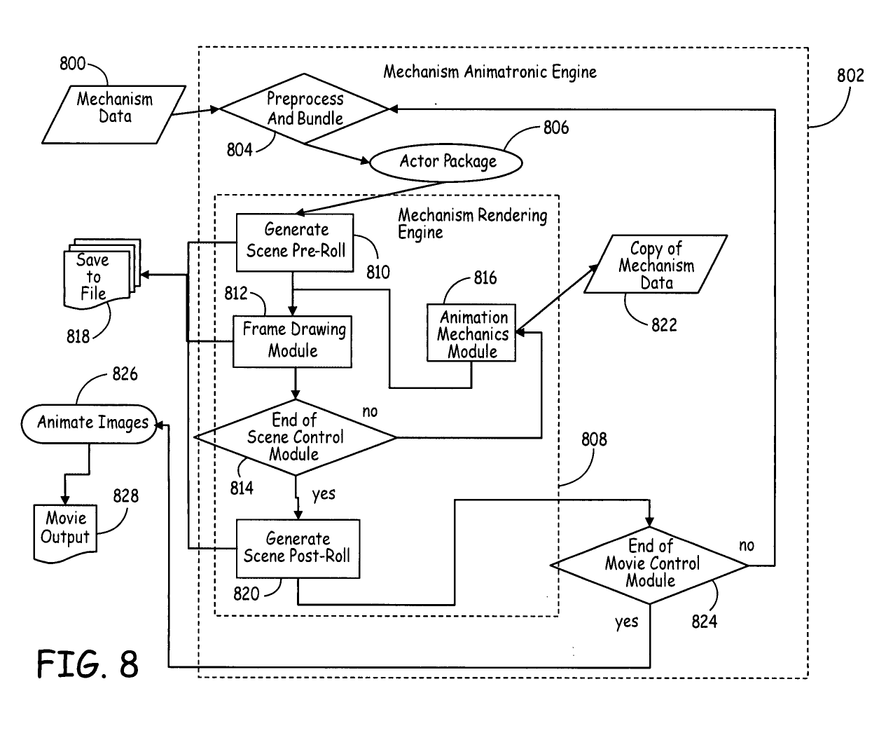

FIG. 8 is a block diagram of the overall program operation. As viewed in FIG. 8, the program is represented by logic blocks for interpreting user input from the graphical user interface (e.g., monitor, keyboard and mouse) and an animatronic engine that deciphers the inputted and stored data to produce a series of animations which without (or with) prompting produce an exportable animation.

User-defined mechanism data 800 is generated in the GUI and transmitted to Mechanism Animatronic Engine (MAE) 802. User-defined mechanism data 800 can be composed from templates; the tools menu; the arrows, fragments, and animation panels; the element and isotopes panels; an accretion; or any combination of the preceding which contains at least one arrow and one node.

MAE 802 pre-processes the stored data in step 804 and sends the actors in scene packages 806, to Mechanism Rendering Engine (MRE) 808. The actor is an object that represents the calculation, manipulation or operation that was applied to the data set (e.g., using an Arrow as described above). For example, the actor is used to symbolize electron movement, rearrangement, resonance, vibration, rotation, projection, relaxation, excitation and combinations thereof. Actors can also symbolize the interactions, behaviors or associations of nuclei currently discovered or as yet undiscovered, the interaction/movement of symbolic nuclei or nuclei accretions/collections with electron(s), and combinations thereof. MRE 808 generally interprets two aspects of each actor—an on-screen aspect (e.g., an arrow line element) and a programmatic aspect that stores the information necessary to facilitate the calculation of the behavior depicted during the continuous animation.

In some instances, user-defined mechanism data 800 can be disordered and the pre-processing of step 804 takes the actors which will be used in the scene generation, and bundles them together to be sent to MRE 808. Actors Package (AP) 806 is a collection of actors operating concurrently (in parallel) during the same scene, or whose actions overlap for all or part of a scene. Actors collected in AP 806 can operate on bonds, nodes, other actors and combinations thereof. Actors can also be used for transient labeling such as color changes, text, images, audio and combinations thereof.

MRE 808 composes scene frames based on input from AP 806. MRE 808 includes a Scene Pre-roll Generator (step 810), a Frame Drawing Module (FDM) (step 812), a Control Module (step 814), Animation Mechanics Module (AMM) 816, and a Scene Post-roll Generator (step 820). In step 810, the Scene Pre-roll Generator generates frames for the scene's pre-roll and saves them to storage device 818 for later animation. After the pre-roll has been completed, the data is sent to the Frame Drawing Module (FDM) in step 812.

The FDM generates the frame to specifications based on the data transmitted from AP 806 and AMM 816. The FDM makes a temporary image to which it adds graphical representations according to AP 806 and AMM 816 and saves the resulting image to storage device 818 to be used in forming the animation.

The Control Module determines whether AP 806 or any of its components have been completed. In one embodiment, this is accomplished by measuring distance traversed along a pseudo-normalized poly-dimensional vector that represents all the data adjustments corresponding to a given actor. For example, in a node to node homolytic electron movement, an electron travels from a first node to a second node along a path represented by an arrow (or other actor). The location of the electron along the arrow is measured to determine whether the electron movement operation has been completed (i.e. the electron has reached the destination node). Control is given to Animation Mechanics Module (AMM) 816 if individual actors in AP 806 have not been completed or to the Scene Post-roll Generator (step 820) if the entire AP 806 has been completed.

AMM 816 processes user-defined mechanism data 800 to generate desired adjustments from AP 806 to mechanism data copy 822. The pseudo-normalized poly-dimensional vector is referenced by the percentage of the scene that has been completed. The processing takes the starting point data (pre-scene) and extrapolates an expected endpoint and progresses the location of the graphical elements and/or data variables by a percentage towards the extrapolated endpoint for the graphical elements and/or data variable, according to the actor referencing it.

In step 820, Scene Post-roll Generator generates frames for the animation post-roll and saves them to storage device 818. After the post-roll has been completed, control is relinquished to a Movie Control Module (MECM) in step 824. The MECM determines whether all conditions in user-defined mechanism data 800 have been met. If they have not been met, MAE 802 pre-processes mechanism data copy 822 and generates a new AP 806 from the previously modified mechanism data copy 822. If the MECM determines in step 824 that all conditions in user-defined mechanism data 800 have been met, the frames are animated by the Animation Engine in step 826. In step 826, the Animation Engine renders movie output 828 from the images stored on storage device 818.

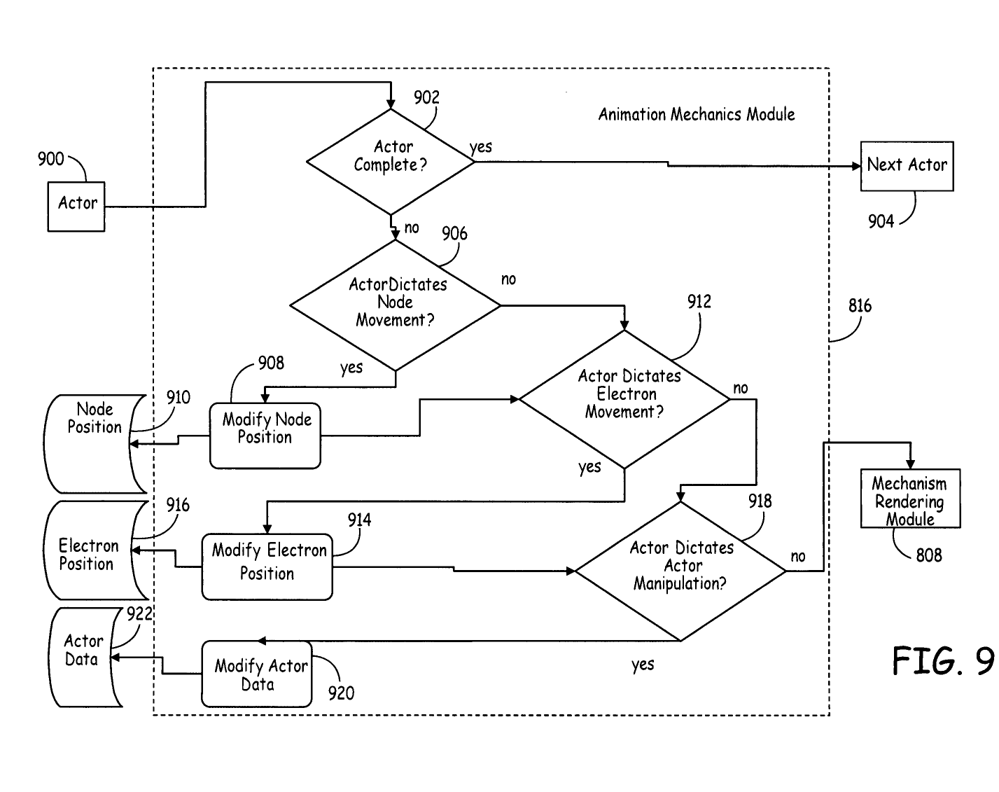

In FIG. 9, Animation Mechanics Module (AMM) 816 is expanded to show its operation in additional detail. Initially, AMM 816 determines if actor information 900 has been completed (step 902). If the current actor has been completed, control is given back to the Mechanism Rendering Engine (MRE) 808 and the process moves on to the next actor (step 904). If the current actor is not yet complete, AMM 816 progresses to step 906.

In step 906, AMM 816 determines if the actor dictates node movement. If node movement is required, one or more nodes are moved appropriately in step 908. Node movement step 908 is applied to the current pertinent parent data using a vectorial approach, and overwrites the parent's node position data 910. If the current actor does not require node movement, AMM 816 proceeds to step 912.

In step 912, AMM 816 determines if the actor dictates electron movement. If electron movement is required, one or more electrons are moved appropriately in step 914. Electron movement step 914 is applied to the current pertinent parent data in a vectorial manner, and overwrites temporary electron position data 916. If the current actor does not require electron movement, AMM 816 proceeds to step 918.

In step 918, AMM 816 determines if the actor dictates manipulation of another actor. If actor manipulation is required, one or more target actors are manipulated appropriately in step 920. Actor manipulation step 920 is applied to the current pertinent parent data and overwrites the parent's actor data 922. If the current actor does not require manipulation, control is given back to MRE 808.

The method of animating a chemical mechanism described herein provides a useful learning tool for those seeking a better understanding of chemical mechanisms. The method allows a user to select one or more initial chemical structures and to carry out one or more operations (mechanisms) on the structure(s). An engine takes the user's selections and determines resulting modified chemical structures. The engine also generates a series of frames which are combined to generate an animation simulating the chemical mechanism selected by the user.

While the invention has been described with reference to exemplary embodiments, it will be understood by those skilled in the art that various changes may be made and equivalents be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiments disclosed, but that the invention will include all embodiments falling within the scope of the appended claims.

1. A method for illustrating a chemical mechanism, the method comprising:
receiving an initial chemical structure selection from a graphical user interface;
receiving an operation input relating to at least a portion of the initial chemical structure from the graphical user interface;
transmitting the initial chemical structure selection and the operation input to an interactive host;
receiving a chemical mechanism animation from the interactive host, wherein the chemical mechanism animation comprises:
the initial chemical structure;
a modified chemical structure; and
one or more sequential transition frames illustrating a transition between the initial chemical structure and the modified chemical structure, wherein the interactive host determines the modified chemical structure and the sequential transition frames based on the initial chemical structure selection and the operation input; and
displaying the chemical mechanism animation on a visual display.

2. The method of claim 1, further comprising storing the chemical mechanism animation as an animated movie, wherein the animated movie is a 2-dimensional or a 3-dimensional animation of the chemical mechanism.

3. The method of claim 1, wherein the one or more sequential transition frames include intermediates and final products.

4. The method of claim 1, wherein the displayed chemical mechanism animation is continuous.

5. The method of claim 1, wherein the displayed chemical mechanism animation depicts a mechanism selected from a group consisting of electron movement, bond formation, bond cleavage, resonance, chemical movements, chemical structure interconversions, chemical structure intraconversions and combinations thereof.

6. The method of claim 1, wherein the initial chemical structure is generated by a user using the graphical user interface and an atomic element database.

7. The method of claim 1, wherein the initial chemical structure is selected from a chemical structure database.

8. The method of claim 1, wherein the displayed chemical mechanism animation depicts movement of electrons during a chemical reaction.

9. The method of claim 1, wherein the initial chemical structure is selected from a group consisting of alkanes, alkenes, alkynes, alkyl groups, aryl groups, alkylhalides, alcohols, ethers, thiols, thioethers, carbonyl groups, aldehydes, ketones, carboxylic acids, carboxylic acid derivatives, amines, aromatic compounds, organometallic compounds and combinations thereof.

10. The method of claim 1, wherein the chemical mechanism is a chemical reaction selected from a group consisting of aliphatic nucleophilic substitutions; aromatic nucleophilic substitutions; aliphatic electrophilic substitutions; aromatic electrophilic substitutions; free radical substitutions; addition to carbon-carbon multiple bonds; addition to carbon-heteroatom multiple bonds; addition to heteroatom-heteroatom multiple bonds; isomerization reactions; elimination reactions; condensation reactions; rearrangements; acid-base reactions; oxidation-reduction reactions; photochemical reactions; pericyclic reactions; reactions of free radicals, carbenes and other reactive intermediates; formulation and reactions of organometallic compounds and combinations thereof.

11. A method for animating a chemical mechanism, the method comprising:
receiving an initial chemical structure input and an operation input relating to at least a portion of the initial chemical structure;
determining a modified chemical structure based on the received initial chemical structure input and operation input;
rendering one or more transition frames illustrating a transition between the initial chemical structure and the modified chemical structure; and
transmitting a chemical mechanism animation to a readable medium, wherein the chemical mechanism animation comprises:
the initial chemical structure;
the one or more transition frames; and
the modified chemical structure.

12. The method of claim 11, further comprising displaying the chemical mechanism animation on a visual display.

13. The method of claim 11, wherein the transition illustrates a mechanism selected from a group consisting of electron movement, bond formation, bond cleavage, resonance, chemical movements, chemical structure interconversions, chemical structure intraconversions and combinations thereof.

14. A method for animating a chemical mechanism, the method comprising:
selecting an initial chemical structure using a graphical user interface;
selecting an operation relating to at least a portion of the initial chemical structure using the graphical user interface;
transmitting the selected initial chemical structure selection and operation to an interactive host;
receiving a chemical mechanism animation from the interactive host, wherein the interactive host determines a modified chemical structure based on the received initial chemical structure input and operation input and renders one or more transition frames illustrating a transition between the initial chemical structure and the modified chemical structure, and wherein the chemical mechanism animation comprises:
the initial chemical structure;
the one or more transition frames; and
the modified chemical structure; and
transmitting the chemical mechanism animation to a readable medium.

15. The method of claim 14, further comprising displaying the chemical mechanism animation on a visual display.

16. A method for illustrating a chemical mechanism, the method comprising:
receiving an initial chemical structure selection from a graphical user interface;
receiving an operation input relating to at least a portion of the initial chemical structure from the graphical user interface;
transmitting the initial chemical structure selection and the operation input to an interactive host;
receiving a modified chemical structure and one or more sequential transition frames illustrating a transition between the initial chemical structure and the modified chemical structure from the interactive host, wherein the interactive host determines the modified chemical structure based on the initial chemical structure selection and the operation input; and
displaying the initial chemical structure, the one or more sequential transition frames and the modified chemical structure on a visual display.

17. The method of claim 16, further comprising storing the initial chemical structure, the one or more sequential transition frames and the modified chemical structure as an animated movie, wherein the animated movie is a 2-dimensional or a 3-dimensional animation of the chemical mechanism.

18. A chemical mechanism animation system comprising:
a database containing chemical structures;
a graphical user interface for receiving selections of an initial chemical structure and an operation to be performed on at least a portion of the initial chemical structure from a user;
an interactive host for determining a modified chemical structure based on the initial chemical structure and operation selections and rendering one or more transition frames illustrating a transition between the initial chemical structure and the modified chemical structure; and
a visual display for displaying an animation comprising:
the initial chemical structure;
the one or more transition frames; and
the modified chemical structure.

19. A computer-readable storage medium encoded with a machine-readable computer program code for animating a chemical mechanism, the computer readable storage medium including instructions to implement a method comprising:
acquiring selections of an initial chemical structure input and an operation input relating to at least a portion of the initial chemical structure;
determining a modified chemical structure based on the received initial chemical structure input and operation input;
rendering one or more transition frames illustrating a transition between the initial chemical structure and the modified chemical structure; and
transmitting a chemical mechanism animation to a readable medium, wherein the chemical mechanism animation comprises:
the initial chemical structure;
the one or more transition frames; and
the modified chemical structure.
